(19) United States
(12) Patent Application Publication
(10) Pub. No.: US 2017/0369047 A1
(43) Pub. Date: Dec. 28, 2017

(54) ELECTRIC BRAKE SYSTEM

(71) Applicants: Mazda Motor Corporation, Hiroshima (JP); Hitachi Automotive Systems, Ltd., Ibaraki (JP)

(72) Inventors: Michiharu OKADA, Hiroshima-shi, Hiroshima (JP); Shigeyuki UEHARA, Hiroshima-shi, Hiroshima (JP); Hiroaki KAWAI, Kawasaki-shi, Kanagawa (JP); Wataru YOKOYAMA, Yokohama-shi, Kanagawa (JP)

(21) Appl. No.: 15/539,836

(22) PCT Filed: Dec. 25, 2015
(86) PCT No.: PCT/JP2015/086183

§ 371 Date: Jun. 26, 2017

(30) Foreign Application Priority Data
Dec. 27, 2014 (JP) 2014-266811

(51) Int. Cl. B60T 17/22; B60T 8/17; B60T 13/74

(52) U.S. Cl. CPC B60T 17/221; B60T 13/741; B60T 8/17; B60T 2270/406

(57) ABSTRACT

An electric brake system includes at least a pair of braking apparatuses each configured to advance a piston for pressing a frictional member against a rotational member rotatable together with a wheel and configured to press the frictional member against the rotational member with use of an electric mechanism according to a braking request signal and hold a pressing force of the frictional member. The electric brake system further includes a control apparatus configured to control the electric mechanism of each of the brake apparatuses and diagnose the failed state in which an abnormality has occurred in each of the brake apparatuses according to the braking request signal. The control apparatus is configured to, when any one of the brake apparatuses is diagnosed as being in the failed state, prohibit the electric mechanism of the one of the brake apparatuses from operating while the vehicle is running.

### TECHNICAL FIELD

The present invention relates to an electric brake system that applies a braking force to a vehicle.

### BACKGROUND ART

There is known an electric brake system configured to activate a brake apparatus (a parking brake) as an auxiliary brake by advancing a piston with use of an electric mechanism, as an electric brake system mounted on a vehicle, such as an automobile (refer to PTL 1).

### CITATION LIST

### Patent Literature

PTL 1: Japanese Patent Application Public Disclosure No. H11-321599

### SUMMARY OF INVENTION

### Technical Problem

One possible operation to deal with such a situation that the electric mechanism of one of left and right brake apparatuses is in a failed state (an abnormality or a failure) is to totally prohibit control (activation) of the electric mechanisms of both the left and right brake apparatuses to, for example, prevent a braking force from being applied to only one wheel. However, carelessly prohibiting even the control while the vehicle is running may result in an incapability to apply the braking force according to a driver's intention even when, for example, the driver turns on a parking brake switch with an attempt to bring the vehicle to an emergency stop.

An object of the present invention is to provide an electric crake system capable of applying the braking force according to the driver's intention even when one of the left and right brake apparatuses is placed in the failed state.

### Solution to Problem

To solve the above-described problem, according to one aspect of the present invention, an electric brake system includes at least a pair of braking apparatuses provided on a left side and a right side of a vehicle. Each of the brake apparatuses is configured to advance a piston for pressing a frictional member against a rotational member rotatable together with a wheel, and configured to press the frictional member against the rotational member with use of an electric mechanism according to a braking request signal and hold a pressing force of the frictional member. The electric brake system further includes a control apparatus configured to control the electric mechanism of each of the brake apparatuses and diagnose a failed state in which an abnormality has occurred in each of the brake apparatuses according to the braking request signal. This control apparatus is configured to, when any one of the brake apparatuses on the left side and the right side is diagnosed as being in the failed state, prohibit the electric mechanism of the one of the brake apparatuses from operating while the vehicle is running.

According to the electric brake system of the one aspect of the present invention, it is possible to apply the braking force according to the driver's intention even when one of the left and right brake apparatuses is placed in the failed state while the vehicle is running.

### BRIEF DESCRIPTION OF DRAWINGS

FIG. 1 is a conceptual drawing illustrating a vehicle on which an electric brake system according to an embodiment is mounted.

FIG. 2 is a vertical cross-sectional view illustrating, in an enlarged manner, a disk brake equipped with an electric parking brake function that is mounted on a rear wheel side illustrated in FIG. 1

FIG. 3 is a block diagram illustrating a parking brake control apparatus illustrated in FIG. 1.

FIG. 4 is a flowchart illustrating control processing designed to be performed by the parking brake control apparatus before emergency stop control is performed.

FIG. 5 illustrates a relationship between control of a left disk brake and control of a right disk brake before the emergency stop control is performed, as a table.

FIG. 6 is a flowchart illustrating control processing designed to be performed while the emergency stop control is in progress.

FIG. 7 illustrates a relationship between control or the left disk brake and control of the right disk brake while the emergency stop control is in progress, as a table.

### DESCRIPTION OF EMBODIMENTS

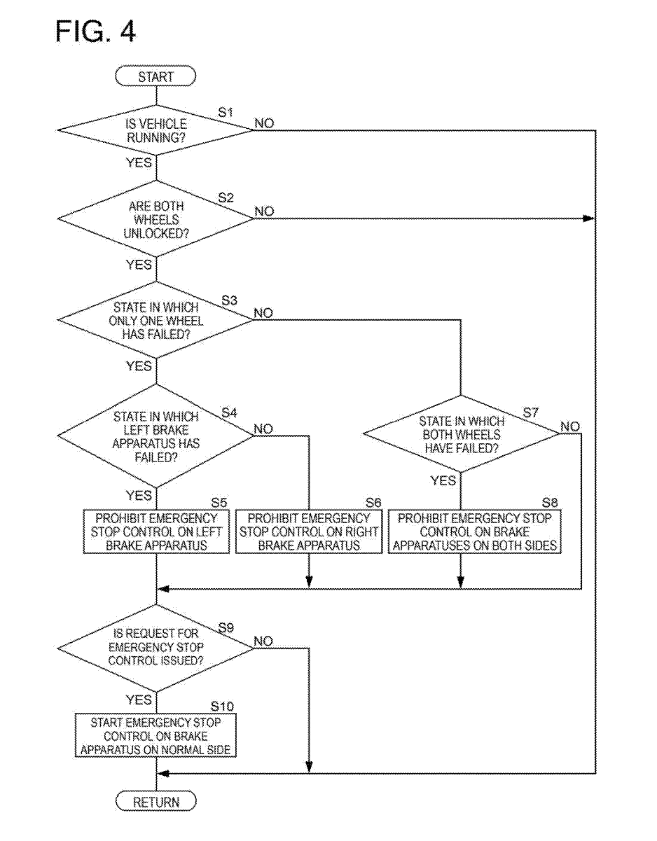

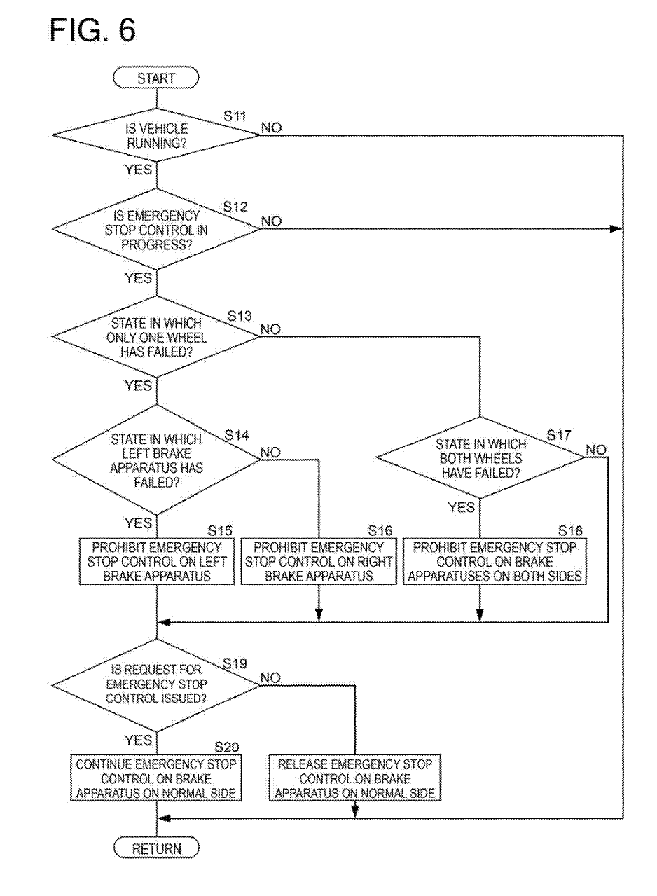

In the following description, an electric brake system according to an embodiment of the present invention will be described in detail based on an example in which the electric brake system is mounted on a four-wheeled automobile with reference to the accompanying drawings. Individual steps in flowcharts illustrated in FIGS. 4 and 6 will be each expressed with use of the symbol “S”, and, for example, step 1 will be expressed as “S1”.

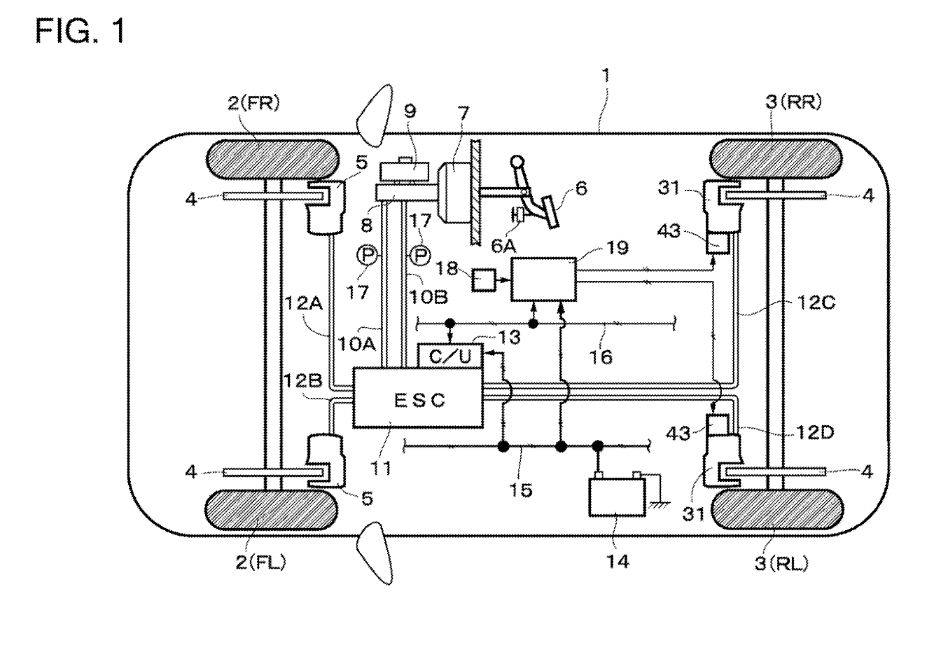

Referring to FIG. 1, four wheels in total that include, for example, front left and right wheels 2 (FL and FR) and rear left and right wheels 3 (RL and RR) are mounted under a vehicle body 1 forming a main structure of a vehicle (on a road surface side). A disk rotor 4 is provided to each of these front wheels 2 and rear wheels 3 as a rotational member rotatable together with each of the wheels (each of the front wheels 2 and each of the rear wheels 3). The disk rotor 4 for the front wheel 2 is subjected to a braking force by a hydraulic disk brake 5, and the disk rotor 4 for the rear wheel 3 is subjected to a braking force by a hydraulic disk brake 31 equipped with an electric parking brake function. Due to this configuration, a barking brake is applied to each of the wheels (each of the front wheels 2 and each of the rear wheels 3) independently of one another.

A brake pedal 6 is provided on a dash board side of the vehicle body 1. The brake pedal 6 is operated by being pressed by a driver at the time of an operation of braking the vehicle, and the braking force as a regular brake (a service brake) is applied and released based on this operation. A brake operation detection sensor (a brake sensor) 6A, such as a brake lamp switch, a pedal switch, and a pedal stroke sensor, is provided at the brake pedal 6. The brake operation detection sensor 6A detects presence or absence Of the operation of pressing the brake pedal 6 and an operation amount thereof, and outputs a detection signal thereof to a hydraulic supply apparatus controller 13. The detection signal of the brake operation detection sensor 6A is transmitted (output to a parking brake control apparatus 19) via, for example, a vehicle data bus 16 or a signal line (not illustrated) connecting the hydraulic supply apparatus controller 13 and the parking brake control apparatus 19 to each other.

The operation of pressing the brake pedal 6 is transmitted to a master cylinder 8 serving as a hydraulic source via a booster 7. The booster 7 is configured as a negative pressure booster or an electric booster provided between the brake pedal 6 and the master cylinder 8, and transmits a pressing force to the master cylinder 8 while boosting the pressing force at the time of the operation of pressing the brake pedal 6. At this time, the master cylinder 8 generates a hydraulic pressure with the aid of brake fluid supplied form a master reservoir 9. The master reservoir 9 includes a hydraulic fluid tank containing the brake fluid therein. The mechanism for generating the hydraulic pressure by the brake pedal 6 is not limited to the above-described configuration, and may be a mechanism that generates the hydraulic pressure according to the operation performed on the brake pedal 6, such as a brake-by-wire type mechanism.

The hydraulic pressure generated in the master cylinder 8 is transmitted to a hydraulic supply apparatus 11 (hereinafter referred to as an ESC 11) via, for example, a pair of cylinder-side hydraulic pipes 10A and 10B. The ESC 11 is disposed between each of the disk brakes 5 and 31 and the master cylinder 8, and distributes the hydraulic pressure from the master cylinder 8 to each of the disk brakes 5 and 31 via brake-side pipe portions 12A, 12B, 12C, and 12D. As a result, the braking force is applied to each of the wheels (each of the front wheels 2 and each of the rear wheels 3) independently of one another.

For achieving this function, the ESC 11 includes a dedicated control apparatus including, for example, a microcomputer, i.e., the hydraulic supply apparatus controller 13 (hereinafter referred to as the control unit 13). The control unit 13 performs control of increasing, reducing, or maintaining the brake hydraulic pressure to be supplied from the brake-side pipe portions 12A to 12D to each of the disk brakes 5 and 31, by performing driving control of opening and closing each of control valves (not illustrated) of the ESC 11 and rotating and stopping an electric motor (not illustrated) for a hydraulic pump. This operation realizes execution of various kinds of brake control, such as boosting control, braking force distribution control, brake assist control, anti-lock brake control (ABS), traction control, vehicle stabilization control (including sideslip prevention), hill start aid control, and automatic driving control.

Power is supplied from a battery 14 to the control tip it 13 via a power source line 15. As illustrated in FIG. 1, the control unit 13 is connected to the vehicle data bus 16. Instead of the ESC 11, a known ABS unit can also be used. Alternatively, the master cylinder 8 and the brake-side pipe portions 12A to 12D can also be directly connected to each other without the provision of the ESC 11 (i.e., with the ESC 11 omitted).

The vehicle data bus 16 includes a CAN (Controller Area Network) as a serial communication unit mounted on the vehicle body 1, and performs in-vehicle multiplex communication between the vehicle data bus 16, and a large number of electronic devices mounted on the vehicle, the control unit 13, the parking brake control apparatus 19, and the like. In this case, examples of vehicle information transmitted to the vehicle data bus 16 include information (vehicle information) based on detection signals from the brake operation detection sensor 6A, a pressure sensor 17 that detects a master cylinder hydraulic pressure (the brake hydraulic pressure), an ignition switch, a safety belt sensor, a door lock sensor, a door opening sensor, a seat occupancy sensor, a vehicle speed sensor, a steering angle sensor, an accelerator sensor (an accelerator operation sensor), a throttle sensor, an engine rotation sensor, a stereo camera, a millimeter-wave radar, an inclination sensor, a shift sensor, an acceleration sensor, a wheel speed sensor, a pitch sensor that detects a motion of the vehicle in a pitch direction, and the like.

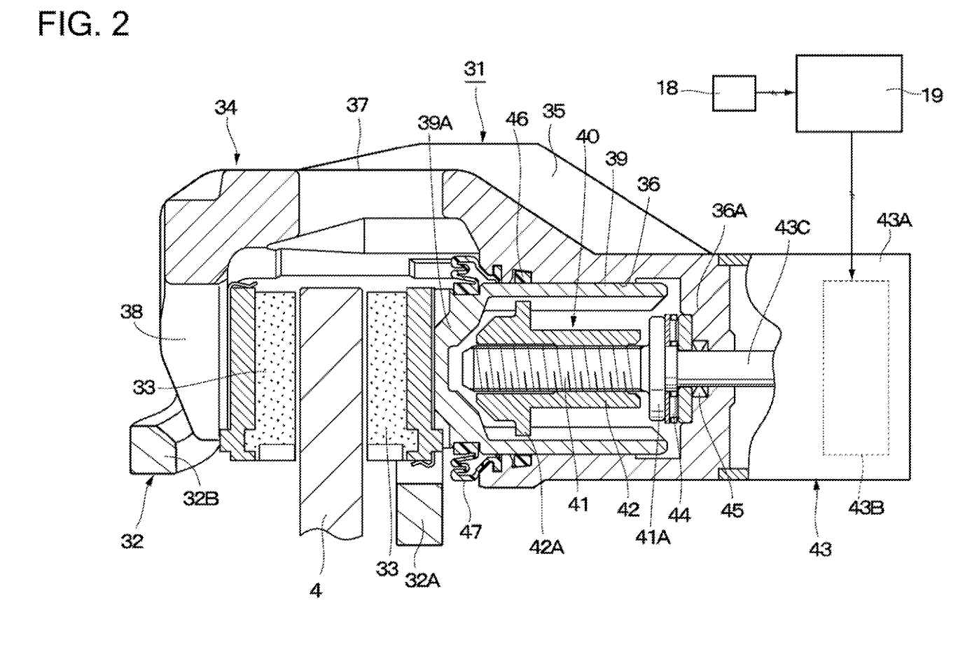

A parking brake switch (PKBSW) 18 is provided in the vehicle body 1 near a driver's seat (not illustrated). The parking brake switch 18 is operated by the driver. The parking brake switch 18 transmits a signal (an activation request signal) corresponding to a request to activate the parking brake (an application request or a release request) issued from the driver to the parking brake control apparatus 19. In other words, the parking brake switch 18 outputs a signal (an application request signal or a release request signal) to activate brake pads 33 (refer to FIG. 2) for the application or the release based on driving (a rotation) of an electric motor 43B to the parking brake control apparatus 19, which serves as a control unit (a controller).

When the parking brake switch 18 is operated by the driver toward a braking side (a parking brake ON side), i.e., when the application request (a holding request or a driving request) for applying the braking force to the vehicle is issued, the application request signal (a braking request signal) is output from the parking brake switch 18. On the other hand, when the parking brake switch 18 is operated by the driver toward a braking release side (a parking brake OFF side), i.e., when the release request (a stop request) for releasing the braking force on the vehicle is issued, the release request signal is output from the parking brake switch 18. In this case, the parking brake can be set into an application state when, for example, the driver pulls up the parking brake switch 18 (operates the parking brake switch 18 to switch on it), and a release state when the driver pushes down the parking brake switch 18 (operates the parking brake switch 18 to switch off it).

When the application request is issued while the vehicle is stopped, power for rotating the electric motor 43B toward a braking side is supplied to the disk brake 31 for the rear wheel 3 via the parking brake control apparatus 19. As a result, the disk brake 31 for the rear wheel 3 is set into a state where the braking force as the parking brake is applied thereto, i.e., an application state.

On the other hand, when the release request is issued while the vehicle is stopped, power for rotating the electric actuator 43 in an opposite direction from the braking side is supplied to the disk brake 31 via the parking brake control apparatus 19. As a result, the disk brake 31 for the rear wheel 3 is set into a state where the application of the braking force as the parking brake is released, i.e., a release state.

The parking brake can be configured to be automatically applied (an automatic application) based on an automatic application request due to a logic for determining the application of the parking brake by the parking brake control apparatus 19, for example, when the vehicle is kept stopped for a predetermined time period (the vehicle is determined to be stopped, for example, when the speed detected by the vehicle speed sensor is kept lower than 4 km/h for a predetermined time period according to deceleration while the vehicle is running), when the engine is stopped, when a shift lever is operated to P, when a door is opened, or when a seat belt is released.

Further, the parking brake can be configured to be automatically released (an automatic release) based on an automatic release request due to a logic for determining the release of the parking brake by the parking brake control apparatus 19, for example, when the vehicle is running (the vehicle is determined to be running, for example, when the speed detected by the vehicle speed sensor is kept at 5 km/h or higher for a predetermined time period according to acceleration from a stopped state), when an accelerator pedal is operated, when a clutch pedal is operated, or when the shift lever is operated to a position other than P and N.

Further, when the application request is issued by the parking brake switch 18 while the vehicle is running, more specifically, when a dynamic parking brake (a dynamic application) using the parking brake as an auxiliary brake urgently while the vehicle is running is requested, power for rotating the electric motor 43B toward the braking side is supplied to the disk brake 31 for the rear wheel 3 via the parking brake control apparatus 19. As a result, the disk brake 31 for the rear wheel 3 is set into a state where the braking force as the auxiliary brake is applied, i.e., the application state. In this case, the parking brake can be set into the application state when, for example, the driver continuously pulls up the parking brake switch 18 (operates the parking brake switch 18 to turn on the braking), and the release state when the driver take his/her hand off the parking brake switch 18 (operates the parking brake switch 18 to turn off the braking).

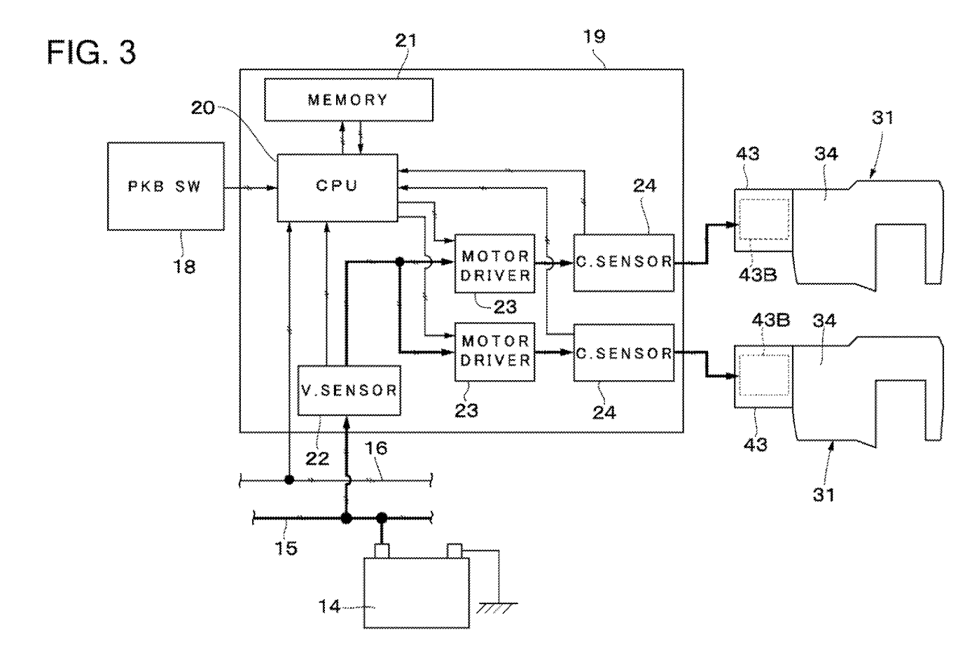

The parking brake control apparatus 19 forms an electric brake system together with the left and right disk brakes 31, which will be described below. As illustrated in FIG. 3, the parking brake control apparatus 19 includes a calculation circuit (CPU) 20 including a microcomputer and the like, and power is supplied from the battery 14 to the parking brake control apparatus 19 via the power source line 15. The parking brake control apparatus 19 forms a control apparatus (a controller or a control unit), which is a component of the present invention, and functions to control the electric actuators 43 of the left and right disk brakes 31 to generate the braking force (the parking brake) when, for example, the vehicle is parked or stopped. In other words, the parking brake control apparatus 19 functions to activate (hold or release) the disk brake 31 as the parking brake or the auxiliary brake.

As illustrated in FIGS. 1 to 3, an input side of the parking brake control apparatus 19 is connected to the parking brake switch 18 and the like, and an output side of the parking brake control apparatus 19 is connected to the electric actuators 43 of the disk brakes 31 and the like. More specifically, as illustrated in FIG. 3, the parking brake switch 18, the vehicle data bus (CAN) 16, a voltage sensor unit 22, motor driving circuits 23, current sensor units 24, and the like, in addition to a storage unit (a memory) 21, are connected to the calculation circuit (CPU) 20 of the parking brake control apparatus 19. The parking brake control apparatus 19 can acquire various kinds of state amounts of the vehicle that are required to control (activate) the parking brake, and various kinds of vehicle information from the vehicle data bus 16.

The parking brake control apparatus 19 may be configured to acquire the vehicle information acquired from the vehicle data bus 16 due to a direct connection of the parking brake control apparatus 19 (the calculation circuit 20 thereof) to the sensors that detect these information pieces (for example, the accelerator sensor, the throttle sensor, the engine rotation sensor, the brake sensor, the wheel speed sensor, the vehicle speed sensor, a G sensor, and the like). Further, the calculation circuit 20 of the parking brake control apparatus 19 can be configured to receive the activation request signal from the parking brake switch 18 and another control apparatus (for example, the control unit 13) connected to the vehicle data bus 16.

In this case, the electric brake system can be configured in such a manner that the other control apparatus (for example, the control unit 13), for example, determines whether to hold/release the parking brake according to the above-described determination logic, instead of the parking brake control apparatus 19. In other words, the control content of the parking brake control apparatus 19 can be integrated into the control unit 13.

The parking brake control apparatus 19 includes the storage unit (memory) 21 (refer to FIG. 3) including, for example, a flash memory, a ROM, a RAM, or an EEPROM. This storage unit 21 stores therein, for example, a program for realizing the above-described logic for determining whether to hold/release the parking brake, and programs for realizing processing illustrated in FIGS. 4 and 6 that will be described below, i.e., processing programs for holding (applying the braking force) and releasing (stopping the braking) the disk brake 31 based on the signal from the parking brake switch 18 while the vehicle is running.

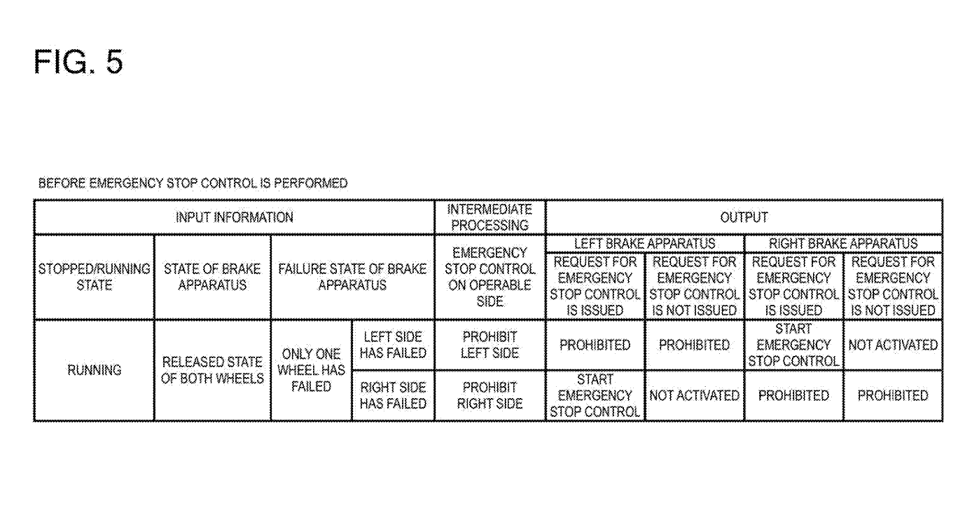

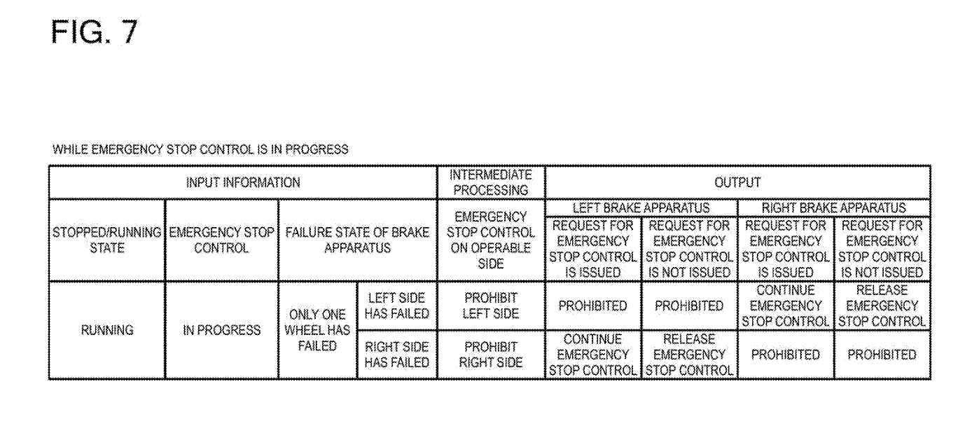

Further, the storage unit 21 stores therein information such as input information, intermediate processing, and an output before emergency stop control is performed while associating them with each other as a map, as indicated by tables illustrated in FIGS. 5 and 7. Then, when the emergency stop control is performed on the left and right disk brakes 31, the left and right disk brakes 31 are controlled according to the processing programs (processing procedures) illustrated in FIGS. 4 and 6 and the tables illustrated in FIGS. 5 and 7.

In the present embodiment, the parking brake control apparatus 19 is configured separately from the control unit 13 of the ESC 11, but may be configured integrally with the control unit 13. Further, the parking brake control apparatus 19 is configured to control the two left and right disk brakes 31, but may be provided for each of the left and right disk brakes 31. In this case, the parking brake control apparatus 19 can also be mounted integrally with the disk brake 31.

The parking brake control apparatus 19 performs stationary application control and dynamic application control on the disk brake 31 depending on the state of the vehicle when the parking brake switch 18 is operated to turn on the braking. The stationary application control is performed when the parking brake switch 18 is operated to turn on the braking while the vehicle is stopped, and generates the braking force for stopping the vehicle on the disk brake 31 when, for example, the parking brake switch 18 is operated by being pulled up.

On the other hand, the dynamic application control is performed when the parking brake switch 18 is operated to turn on the braking while the vehicle is running, and, for example, gradually generates the braking force on the disk brake 31 when the parking brake switch 18 is continuously pulled up, and releases the braking force on the disk brake 31 when the driver takes his/her hand off the parking brake switch 18.

As illustrated in FIG. 3, the parking brake control apparatus 19 includes, as built-in units thereof, the voltage sensor unit 22 that detects a voltage from the power source line 15, the left and right motor driving circuits 23 and 23 that drive the left and right electric actuators 43 and 43, respectively, the left and right current sensor units 24 and 24 that detect respective motor current values of the left and right electric actuators 43 and 43, and the like. These voltage sensor unit 22, motor driving circuits 23, and current sensor units 24 are each connected to the calculation circuit 20.

Due to this configuration, the calculation circuit 20 of the parking brake control apparatus 19 can stop driving the electric actuator 43 based on the motor current value of this electric actuator 43 when, for example, holding (applying) and stopping (releasing) the parking brake. In this case, the calculation circuit 20 determines that a state of the piston 39 established by a rotation-linear motion conversion mechanism 40 transitions to a holding state or a release state when, for example, the motor current value reaches a preset holding threshold value or release threshold value, and stops driving the electric actuator 43.

Further, when the ignition switch is turned on, the parking brake control apparatus 19 regularly diagnoses an abnormality (a failure) in the left and right disk brakes 31 after that (until the ignition switch is turned off). In this case, the parking brake control apparatus 19 diagnoses at least whether the disk brake 31 subjected to the braking request signal is in an abnormal failed i.e., whether the operation of the disk brake 31 subjected to the broking request signal is normal.

More specifically, the calculation circuit 20 of the parking brake control apparatus 19 can detect the abnormality (the failure) in the disk brake 31, in particular, the abnormality (the failure) in the rotation-linear motion conversion mechanism 40 and the electric actuators 43, according to, for example, the voltage from the power source line 15 (the voltage input to the parking brake control apparatus 19) and the motor current value of the left or right electric actuator 43. Further, the calculation circuit 20 of the parking brake control apparatus 19 can also detect a parameter required to activate the brake apparatus, such as a battery voltage, and a failure in a driving circuit and the like. Further, the parking brake control apparatus 19 (ECU) can also detect an abnormality in a battery voltage monitor, a motor terminal voltage monitor, a relay downstream voltage monitor, and a current monitor, besides each of the above-described detection of the abnormalities.

In this case, the calculation circuit 20 can determine, for example, whether any of the left and right disk brakes 31 is normal (for example, the present state is any of a state in which the left wheel has failed, a state in which the right wheel has failed, a state in which both the left and right wheels have failed, and a state in which both the left and right wheels are normal), whether this failure is a physical abnormality or controllable, based on, for example, a difference in the motor current value and a change therein.

Further, the parking brake control apparatus 19 also determines whether the parking brake control apparatus 19 itself is normal, i.e., makes a self-diagnosis. As this determination, the parking brake control apparatus 19 can make the self-diagnosis according to, for example, whether a predetermined signal, a predetermined operation, a predetermined calculation result, or the like can be acquired when a predetermined signal (a self-check signal) is fed to the calculation circuit 20, the voltage sensor unit 22, or the current sensor unit 24, or when the calculation circuit 20 performs a predetermined calculation.

The failure information of the disk brake 31 and the parking brake control apparatus 19 is stored in the storage unit 21, and required processing is performed according to this failure information. More specifically, the failure information is used to determine, based on the operation on the parking brake switch 18 (the braking request signal), whether to apply the braking force to the left and right disk brakes 31 (to perform the emergency stop control) while the vehicle is running. A result of the diagnosis made by the parking brake control apparatus 19, i.e., the state in which the left wheel has failed, the state in which the right wheel has failed, and the state in which both the left and right wheels have failed are reported to the driver with use of a reporting means, such as a display device, an alarm, or a voice synthesizer.

Now, in the present embodiment, when the braking request to request the holding (the application) of the parking brake is issued while the vehicle is running, the parking brake control apparatus 19 activates the electric actuator 43 so as to advance the piston 39 on the normal wheel based on the failure states of the left and right disk brakes 31 that are stored in the storage unit 21. In other words, for example, when the brake pedal 6 is stuck, the booster 7 has failed, or the fluid pressure (the hydraulic pressure) is lost while the vehicle is running, the driver may operate the parking brake switch 18 to turn on the braking (the application request signal may be output from the parking brake switch 18) to bring the vehicle to an emergency stop (acquire the braking force).

In this case, when the storage unit 21 stores therein that both the left and right disk brakes 31 are in the normal state, the parking brake control apparatus 19 activates the electric actuators 43 so as to advance the pistons 39 on both the left and right disk brakes 31.

On the other hand, when the storage unit 21 stores therein that any one of the left and right disk brakes 31 is in the failed state, the parting brake control apparatus 19 prohibits the operation of this disk brake 31 in the failed state. Then, the parking brake control apparatus 19 activates the electric actuator 43 so as to advance the piston 39 of the other disk brake 31 stored as the normal state.

At this time, the parking brake control apparatus 19 can avoid a spin of the vehicle due to sudden braking by, for example, activating (driving) the electric actuator 43 so as to more gradually generate the braking force (the pressing force) than the braking force at the time of the application while the vehicle is stopped. Further, the parking brake control apparatus 19 can also perform ABS control of activating or releasing the electric actuator 43 based on the wheel speed information detected by the control unit 13 of the ESC 11 to prevent or reduce a slip of the wheel. Further, the driver may be notified that the emergency stop control is in progress, i.e., the electric actuator 43 is advancing the piston 39 while the vehicle is running, for example, with use of the report means, such as the display device, the alarm, or the voice synthesizer.

In the present embodiment, even when any one of the left and right disk brakes 31 is diagnosed as having the abnormality (the failure), the braking force can be generated on the disk brake 31 on the other normal wheel according to a driver's intention. As a result, even when any one of the left and right disk brakes 31 has the abnormality, the vehicle can be brought to the emergency stop when the driver operates the parking brake switch 18 to turn on the braking.

Next, a configuration of each of the disk brakes 31 and 31 equipped with the electric parking brake function that are mounted on the left and right rear wheels 3 and 3, respectively, will be described with reference to FIG. 2. FIG. 2 illustrates only one of the left and right disk brakes 31 and 31 respectively mounted in correspondence with the left and right rear wheels 3 and 3.

The disk brake 31 as the brake apparatus is mounted on each of the left side and the right side of the vehicle. These disk brakes 31 are each configured as a hydraulic disk brake equipped with the electric parking brake function. The disk brake 31 forms a brake system (the brake apparatus) together with the parking brake control apparatus 19. The disk brake 31 includes a mount member 32 attached to a non-rotatable portion on the rear wheel 3 side of the vehicle, the inner-side and outer-side brake pads 33 as a braking member (a fractional member), and a caliper 34 as a brake mechanism provided with the electric actuator 43.

In this case, the disk brake 31 applies the braking force to the wheel (the rear wheel 3) and thus the vehicle by advancing the brake pads 33 by the piston 39 with the aid of the hydraulic pressure based on, for example, the operation performed on the brake pedal 6 to press the disk rotor 4 with the brake pads 33. In addition thereto, the disk brake 31 applies the braking force to the wheel (the rear wheel 3) and thus the vehicle by advancing the piston 39 with use of the electric motor 43B (via the rotation-linear motion conversion mechanism 40) to press the disk rotor 4 with the brake pads 33 according to the activation request based on the signal from the parking brake switch 18, or the activation request based on the above-described logic for determining the application or the release or line parking brake, or the ABS control.

The mount member 32 includes a pair of arm portions (not illustrated), a thick support portion 32A, and a reinforcement beam 32B. The pair of arm portions extends in an axial direction of the disk rotor 4 (i.e., a disk axial direction) over an outer periphery of the disk rotor 4 and is spaced apart from each other in a disk circumferential direction. The support portion 32A is provided so as to integrally couple respective proximal end sides of these arm portions with each other and is fixed to the non-rotatable portion of the vehicle at a position on an inner side of the disk rotor 4. The reinforcement beam 32B couples respective distal end sides of the arm portions with each other at a position on an outer side of the disk rotor 4.

The inner-side and outer-side brake pads 33 axe disposed so as to be able to abut against both surfaces of the disk rotor 4, and are supported so as to be movable in the disk axial direction by each of the arm portions of the mount member 32. The inner-side and outer-side brake pads 33 are pressed against the both surface sides of the disk rotor 4 by the caliper 34 (a caliper main body 35 and the piston 39). Due to this configuration, the brake pads 33 apply the braking force to the vehicle by pressing the disk rotor 4 rotating together with the wheel (the rear wheel 3).

The caliper 34, which serves as a wheel cylinder, is disposed at the mount member 32 so as to extend over the outer peripheral side of the disk rotor 4. The caliper 34 includes the caliper main body 35, the piston 39, the rotation-linear motion conversion mechanism 40, the electric actuator 43, and the like. The caliper main body 35 is supported movably along the axial direction of the disk rotor 4 relative to the each of the arm portions of the mount member 32. The piston 39 is provided in this caliper main body 35. The caliper 34 advances the brake pads 33 with use of the piston 39 activated by the hydraulic pressure generated based on the operation performed on the brake pedal 6.

The caliper main body 35 includes the cylinder portion 36, a bridge portion 37, and a claw portion 38. The cylinder portion 36 is formed into a bottomed cylindrical shape having one axial side closed by a partition wall portion 36A, and another axial side facing the disk rotor 4 that is opened. The bridge portion 37 is formed so as to extend from this cylinder portion in the disk axial direction as if straddling the outer peripheral side of the disk rotor 4. The claw portion 38 is arranged so as to extend radially inwardly from the bridge portion 37 on an opposite side from the cylinder portion 36, and abut against the outer-side brake pad 33 from a back surface side thereof.

The hydraulic pressure is supplied into the cylinder portion 36 of the caliper main body 35 via the brake-side pipe portion 12C or 12D illustrated in FIG. 1 according to, for example, the operation of pressing the brake pedal 6. This cylinder portion 36 is formed integrally with the partition wail portion 36A. The partition wall portion 36A is located between the cylinder portion 36 and the electric actuator 43. The partition wall portion 36A includes an axial through-hole, and an output shaft 43C of the electric actuator 43 is rotatably inserted on an inner peripheral side of the partition wail portion 36A.

The piston 39 as a pressing member (a movable member), and the rotation-linear motion conversion mechanism 40 are provided in the cylinder portion 36 of the caliper main body 35. In the present embodiment, the rotation-linear motion conversion mechanism 40 is contained in the piston 39. However, the rotation-linear motion conversion mechanism 40 does net necessarily have to be contained in the piston 39 as long as the rotation-linear motion conversion mechanism 40 is configured to advance the piston 39.

The piston 39 displaces the brake pad 33 toward or away from the disk rotor 4. One axial side of the piston 39 is opened, and the other axial side of the piston 39 that faces the inner-side brake pad 33 is closed by a cover portion 39A. This piston 39 is inserted in the cylinder portion 36.

The piston 39 is also displaced due to the supply of the hydraulic pressure into the cylinder portion 36 based on the pressing of the brake pedal 6 or the like, in addition to being displaced due to the supply of the current to the electric actuator 43 (the electric motor 43B). In this case, the piston 39 is displaced by the electric actuator 43 (the electric motor 43B) by being pressed by a linearly movable member 42. Further, the rotation-linear motion conversion mechanism 40 is contained inside the piston 39, and the piston 39 is configured to be advanced in art axial direction of the cylinder portion 36 by this rotation-linear motion conversion mechanism 40.

The rotation-linear motion conversion mechanism 40 functions as a pressing member holding mechanism. More specifically, the rotation-linear motion conversion mechanism advances the piston 39 in the caliper 34 by an external force different from the force generated by the supply of the hydraulic pressure into the cylinder port ion 36, i.e., the force generated by the electric motor 43, and also holds the advanced piston 39 and line brake pads 33 there. As a result, the parking brake is set into the application state (the holding state). On the other hand, the rotation-linear motion conversion mechanism 40 retracts the piston 39 in an opposite direction from the advancing direction by the electric actuator 43, thereby setting the parking brake into the release state (the stop state). Then, because the left and right disk brakes 31 are provided for the left and right rear wheels 3, respectively, the rotation-linear motion conversion mechanisms 40 and the electric actuators 43 are also provided on the left and right sides of the vehicle, respectively.

The rotation-linear motion conversion mechanism 40 includes a screw member 41 and the linearly movable member 42 (as a spindle nut mechanism). The screw member 41 includes a rod-like body with a male screw such as a trapezoidal screw thread formed thereon. The linearly movable member 42 includes a female screw hole formed by a trapezoidal screw thread on an inner peripheral side thereof. The linearly movable member 42 serves as a driven member (an advancing member) displaced toward or away from the piston 39 by the electric actuator 43. In other words, the screw member 41 threadably engaged with the inner peripheral side of the linearly movable member 42 forms a screw mechanism that converts a rotational motion by the electric actuator 43 into a linear motion of the linearly movable member 42. In this case, the female screw of the linearly movable member 42 and the male screw of the screw member 41 are formed with use of highly irreversible screws, in particular, the trapezoidal screw threads in the present embodiment, thereby realizing the pressing member holding mechanism.

The rotation-linear motion conversion mechanism 40 is configured to hold the linearly movable member 42 (i.e., the piston 39) at an arbitrary position with the aid of a frictional force (a holding force) even when the power supply to the electric motor 43 is stopped. The rotation-linear motion conversion mechanism 40 may be any mechanism that can hold the piston 39 at a position to which the piston 33 is advanced by the electric actuator 43. For example, the rotation-linear motion conversion mechanism 40 may be realized with use of another highly irreversible screw than the trapezoidal screw thread, such as a normal screw triangular in cross-section or a worm gear.

The screw member 41 provided while being threadably engaged with the inner circumferential side of the linearly movable member 42 includes a flange portion 41A as a large-diameter flange portion on one axial side, and the other axial side of the screw member 41 extends toward the cover portion 39A of the piston 39. The screw member 41 is integrally coupled with the output shaft 43C of the electric actuator 43 at the flange portion 41A. Further, an engagement protrusion 42A is provided on an outer peripheral side of the linearly movable member 42. The engagement protrusion 42A prohibits the linearly movable member 42 from rotating relative to the piston 39 (regulates a relative rotation) while allowing the linearly movable member 42 to axially move relative to the piston 39. Due to this configuration, the linearly movable member 42 linearly moves by being driven by the electric motor 43B, and contacts the piston 39 to displace this piston 39.

The electric actuator 43 as an electric mechanism is fixed to the caliper main body 35 of the caliper 34. The electric actuator 43 activates (holds/releases) the disk brake 31 according to the activation request signal of the parking brake switch 18, the above-described logic for determining the application or she release of the parking brake, or the ABS control. The electric actuator 43 includes a casing 43A, the electric motor 43B, a speed reducer (not illustrated) and the output shaft 43C. The casing 43A is attached to an outside of the partition wall portion 36A. The electric motor 43B is located in this casing 43A, includes: a stator, a rotor, and the like, and displaces the piston 39 due to supply of power (a current) thereto. The speed reducer amplifies a torque of this electric motor 43B. The output shaft 43C outputs the rotational torque after the torque is amplified fay this speed reducer.

The electric motor 43B can be configured as, for example, a direct-current brushed motor. The output shaft 43C extends axially through the partition wall, portion 36A of the cylinder portion 36, and is coupled with an end of the flange portion 41A of the screw member 41 in the cylinder portion 36 so as to rotate integrally with the screw member 41.

A coupling mechanism between the output shaft 43C and the screw member 41 can be configured so as to, for example, allow them to move in the axial direction but prohibit them from rotating in the rotational direction. In this case, the output shaft 43B and the screw member 41 are coupled with each other with use of a known technique such as spline fitting or fitting using a polygonal rod (non-circular fitting). The speed reducer may be embodied with use of, for example, a planetary gear reducer or a worm gear reducer. Further, in a case where the speed reducer is embodied with use of a known speed reducer unable to operate reversely (an irreversible speed reducer) such as the worm gear reducer, a known reversible mechanism such as a ball screw or a ball ramp mechanism can be used as the rotation-linear motion conversion mechanism 40. In this case, the pressing member holding mechanism can be realized by, for example, the reversible rotation-linear motion conversion mechanism and the irreversible speed reducer.

When the driver operates the parking brake switch 18 illustrated in FIGS. 1 to 3 toward the braking application side (operates the parking brake switch 18 to turn on the braking), power is supplied to the electric motor 43B via the parking brake control apparatus 19, and the output shaft 41C of the electric actuator 43 is rotated. Therefore, the so rev member 41 of the rotation-linear motion conversion mechanism 40 is rotated integrally with the output shaft 43C in one direction, and advances (drives) the piston 39 toward the disk rotor 4 side via the linearly movable member 42. As a result, the disk brake 31 sandwiches the disk rotor 4 between the inner-side and outer-side brake pads 33, thereby being set into the state applying the braking force as the electric parking brake, i.e., the application state (the holding state).

On the other hand, when the parking brake switch 18 is operated toward the braking release side (operated to turn off the braking), the screw member 41 of the rotation-linear motion conversion mechanism 40 is rotationally driven by the electric actuator 43 in the other direction (the reverse direction). As a result, the linearly movable member 42 (and the piston 39 if the hydraulic pressure is not supplied) is driven away from the disk rotor 4, whereby the disk brake 31 is set into the state releasing the application of the braking force as the parking brake, i.e., the stop state (the release state).

In this case, in the rotation-linear motion conversion mechanism 40, when the screw member 41 is rotated relative to the linearly movable member 42, the rotation of the linearly movable member 42 in the piston 39 is regulated. Therefore, the linearly movable member 42 axially relatively moves according to a rotational angle of the screw member 41. In this manner, the rotation-linear motion conversion mechanism 40 converts the rotational motion into the linear motion, thereby causing the linearly movable member 42 to advance the piston 39. Further, along therewith, the rotation-linear motion conversion mechanism 40 holds the linearly movable member 42 at the arbitrary position with the aid of the frictional force with the screw member 41, thereby holding the piston 39 and the brake pads 33 at the positions to which they ate advanced by the electric actuator 43.

A thrust bearing 44 is provided on the partition wail portion 36A of the cylinder portion 36 between this partition wall portion 36A and the flange portion 41A of the screw member 41. This thrust bearing 44 receives a thrust load from the screw member 41 together with the partition wail portion 36A, and facilitates a smooth rotation of the screw member 41 relative to the partition wall portion 36A. Further, a seal member 45 is provided on the partition wall portion 36A of the cylinder portion 36 between the partition wall portion 36A and the output shaft 43C of the electric actuator 43. This seal member 45 seals between the partition wall portion 36A and the output shaft 43C so as to prevent the brake fluid in the cylinder portion 36 from leaking toward the electric actuator 43 side.

Further, a piston seal 46 and a dust boot 47 are provided on the opening end side of the cylinder portion 36. The piston seal 46 serves as an elastic seal for sealing between this cylinder portion 36 and the piston 39. The dust boot 47 prevents a foreign object from entering the cylinder portion 36. The dust boot 47 is a flexible bellows-like seal member, and is attached between the opening end of the cylinder portion 36 and an outer periphery of the cover portion 39A side of the piston 39.

The disk brake 5 for the front wheel 2 is configured in an approximately similar manner to the disk brake 31 for the rear wheel 3, except for the provision of the parking brake mechanism. In other words, the disk brake 5 for the front wheel 2 does not include the rotation-linear motion conversion mechanism 40, the electric actuator 43, and the like chat are activated as the parking brake, which the disk brakes 31 for the rear wheel 3 includes. However, the disk brake 31 equipped with the electric parking brake function may be provided for the front wheel 2 side, instead of the disk brake 5.

The present embodiment has been described based on the hydraulic disk brake 31 including the electric actuator 43 by way of example. However, the configuration thereof does not necessarily have to be the brake mechanism according to the above-described embodiment, as long as this configuration is a brake mechanism that can press (advance) the braking member (the pad or the shoe) against the braking target member (the disk rotor or the drum) based on the driving by the electric actuator (the electric motor) and hold this pressing force, such as an electric disk Crake including an electric caliper, an electric drum brake that applies the braking force by pressing a show against a drum with use of an electric actuator, a disk brake equipped with an electric drum-type parking brake, and a configuration that activates the parking brake for applying the braking by pulling a cable with use of an electric actuator.

The brake apparatus of the four-wheeled automobile according to the present embodiment is configured in the above-described manner, and an operation thereof will be described next.

When the driver of the vehicle operates the brake pedal 6 by pressing it, this pressing force is transmitted to the master cylinder 8 via the booster 7, and the brake hydraulic pressure is generated by the master cylinder 8. The hydraulic pressure generated in the master cylinder 8 is distributed to each of the disk brakes 5 and 31 via the cylinder-side hydraulic pipes 10A and 10B, the ESC 11, and the brake-side pipe portions 12A, 12B, 12C, and 12D, thereby applying the braking force to each of the front left and right wheels 2 and the rear left and right wheels 3.

In this case, the disk brake 31 on the rear wheel 3 side operates in the following manner. The hydraulic pressure is supplied into the cylinder portion 36 of the caliper 34 via the brake-side pipe portion 12C or 12D, and the piston 39 is slidably displaced toward the inner-side brake pad 33 according to an increase in the hydraulic pressure in the cylinder portion 36. As a result, the piston 39 presses the inner-side brake pad 33 against one side surface of the disk rotor 4. A reaction force at this time causes the whole caliper 34 to be slidably displaced toward the inner side relative to each of the above-descried arm portions of the mount member 32.

As a result, the outer leg portion (the claw portion 38) of the caliper 34 operates so as to press the outer-side brake pad 33 against the disk rotor 4, and the disk rotor 4 is sandwiched from axial both sides by the pair of brake pads 33. As a result, the braking force based on the hydraulic pressure is generated. On the other hand, when the brake operation is released, the supply of the hydraulic pressure into the cylinder portion 36 is stopped, which causes the piston 39 to be displaced so as to be retracted into the cylinder portion 36. As a result, the inner-side and outer-side brake pads 33 are each separated from the disk rotor 4, whereby the vehicle is returned into a non-braked state.

Next, when the driver operates the parking brake switch 18 toward the braking side (operates the parking brake switch 18 to turn on the braking) while the vehicle is stopped, the application request signal is output. In this case, the parking brake control apparatus 19 performs the stationary application control. Then, power is supplied from the parking brake control apparatus 19 to the electric actuator 43 of the disk brake 31, whereby the output shaft 43C of the electric actuator 43 is rotationally driven. The disk brake 31 equipped with the electric parking brake function converts the rotational motion of the electric actuator 43 into the linear motion of the linearly movable member 42 via the screw member 41 of the rotation-linear motion conversion mechanism 40 to axially move the linearly movable member 42 to advance the piston 39. As a result, the pair of brake pads 33 is pressed against the both surfaces of the disk rotor 4.

At this time, the linearly movable member 42 is maintained in the braking state with the aid or the frictional force (the holding force) generated between the linearly movable member 42 and the screw member 41 with a pressing reaction force transmitted from the piston 39 serving as a normal force, whereby the disk brake 31 for the rear wheel 3 is activated (applied) as the parking brake. In other words, even after the power supply to the electric motor 43B is stopped, the linearly movable member 42 (thus, the piston 39) is held at the braking position by the female screw of the linearly movable member 42 and the male screw of the screw member 41.

On the other hand, when the driver operates the parking brake switch 18 toward the braking release side (operates the parking brake switch 18 to turn off the braking), power is supplied from the parking brake control apparatus 19 to the electric motor 43B for rotating the motor in the reverse direction, whereby the output shaft 43C of the electric actuator 43 is rotated in the direction opposite to that at the time of the activation (application) of the parking brake. At this time, the holding of the braking force by the screw member 41 and the linearly movable member 42 is released, and the rotation-linear motion conversion mechanism 40 moves the linearly movable member 42 in a return direction, i.e., into the cylinder portion 36 by a movement amount corresponding to an amount of the reverse rotation of the electric actuator 43, thereby releasing the braking force of the parking brake (the disk brake 31).

Then, one possible operation to deal with such a situation that one electric actuator 43 of one of left and right disk brakes 31 is in the failed state (the abnormality or the failure) is to totally prohibit the control (the activation) of the electric actuators 43 of both the left and right disk brakes 31 to, for example, prevent the braking force from being applied to only one wheel. On the other hand, when, for example, the brake pedal 6 is stuck, the booster 7 has failed, or the fluid pressure (the hydraulic pressure) is lost while the vehicle is running, the driver may operate the parking brake switch 18 to turn on the braking so as to activate the parking brake as the auxiliary brake (an emergency brake) with an attempt to stop the vehicle (the emergency stop). Therefore, carelessly prohibiting even the control while the vehicle is running may result in an incapability to apply the braking force according to a driver's intention even when, for example, the driver operates the parking brake switch 18 to turn on the braking with an attempt to bring the vehicle to the emergency stop.

Therefore, in the present embodiment, the parking brake control apparatus 19 is configured to, even when any one of the left and right disk brakes 31 is diagnosed as having the abnormality (the failure), be able to generate the braking force on the disk brake 31 for the other normal wheel according to the driver's intention (the driver's operating the parking brake switch 18 to turn on the braking).

In other words, the parking brake control apparatus 19 is configured to, when any one of the left and right disk brakes 31 is diagnosed as being in the failed state, prohibit the electric actuator 43 of the one of the disk brakes 31 from operating while the vehicle is running and cause the electric actuator 43 of the other of the disk brakes 31 to operate according to the braking request signal.

In the following description, the control processing performed by the calculation circuit 20 of the parking brake control apparatus 19 will be described with reference to FIG. 4.

When the processing operation illustrated in FIG. 4 is started, in S1 (step 1), the calculation circuit 20 determines whether the vehicle is running. The calculation circuit 20 can make this determination, about, whether the vehicle is running based on, for example, the wheel speed and/or the vehicle speed acquired via the vehicle data bus 16. If the calculation circuit 20 determines “YES” in S1, i.e., determines that the vehicle is running, the operation proceeds to S2. On the other hand, if the calculation circuit 20 determines “NO” in S1, i.e., determines that the vehicle is not running (the vehicle is stopped), the operation proceeds to RETURN.

In S2, the calculation circuit 20 determines whether tooth the wheels in the left and right directions are in an unlocked state. The calculation circuit 20 can make this determination based on, for example, the signal from the wheel speed sensor that is acquired via the vehicle data has 16. If the calculation circuit 20 determines “YES” in S2, i.e., determines that both the wheels are unlocked, the operation proceeds to S3. On the other hand, if the calculation circuit 20 determines “NO” in S2, i.e., determines that at least one of the wheels is in a locked state, the operation proceeds to RETURN. The determination about whether both the wheels are in the unlocked state may be omitted.

In S3, the calculation circuit 20 determines whether only any one wheel of the left and right disk brakes 31 is in the failed state. The calculation circuit 20 makes this determination based on the failure information for each of the left and right disk brakes 31 that is stored in the storage unit 21 of the parking brake control apparatus 19 as described above. In other words, the parting brake apparatus 19 regularly diagnoses the abnormality (the failure) in the left and right disk brakes 31 when the ignition switch is turned on, and such failure information is stored in an updatable manner in the storage unit 21, for example, as indicated by the table designed to be used before the emergency stop control is performed illustrated in FIG. 5.

More specifically, the storage unit 21 stores therein whether the failure state of the brake apparatus is the state in which only one wheel has failed, the state in which the left wheel has failed, the state in which the right wheel has failed, the state in which both the left and right wheels have failed, or the state in which both the left and right wheels are normal, as the input information before the emergency stop control is performed illustrated in FIG. 5. Further, the failure information is information regarding whether the activation of the disk brake 31 due to the braking request signal is normal. In other words, the failure information does not include a failure (a failed state) in the activation of the disk brake 31 due to, for example, a loss of the hydraulic pressure.

If the calculation circuit 20 determines “YES” in S3, i.e., determines that the failure state of the brake apparatus is the state in which only one wheel has failed, the operation proceeds to S4. On the other hand, if the calculation circuit 20 determines “NO” in S3, i.e., determines that the failure state of the brake apparatus is not the state in which only one wheel has failed, the operation proceeds to step S7. In the next step, S4, the calculation circuit 20 determines whether the left brake apparatus (the disk brake 31 on the left side) is in the failed state. The calculation circuit 20 makes this determination based on the state in which the left wheel has failed and the state in which the right wheel has failed that are stored in the storage unit 21.

If the calculation circuit 20 determines “YES” in S4, i.e., determines that the failure state of the brake apparatus is the state in which the left wheel has failed, the operation proceeds to the next step, step S5, where the calculation circuit 20 prohibits the emergency stop control on the left brake apparatus (the disk brake 31 on the left side). Then, the operation proceeds to the next step, S9. On the other hand, if the calculation circuit 20 determines “NO” in S4, i.e., determines that the failure state of the brake apparatus is the state in which the right wheel has failed, the operation proceeds to the next step, step S6, where the calculation circuit 20 prohibits the emergency stop control on the right brake apparatus (the disk brake 31 on the right side). Then, the operation proceeds to the next step, S9.

In S7, the calculation circuit 20 determines whether the failure state of the brake apparatus is the state in which both the wheels have failed. The calculation circuit 20 makes this determination based on the state in which both the left and right wheels have failed and the state in which both the left and right wheels are normal that axe stored in the storage unit 21. If the calculation circuit 20 determines “YES” in S7, i.e., determines that the failure state of the brake apparatus is the state in which both the left and right wheels have failed, the operation proceeds to the next step, S8, where the calculation circuit 20 prohibits the emergency stop control on the brake apparatuses on the both sides (the left and right disk brakes 31). Then, the operation proceeds to the next step, S9. On the other hand, if the calculation circuit 20 determines “NO” in S7, i.e., determines that the failure state of the brake apparatus is the state in which both the left and right wheels are normal, the operation proceeds to the next step, S9.

In S9, the calculation circuit 20 determines whether the request for the emergency stop control (the dynamic application request) is issued. The calculation circuit 20 makes this determination based on whether the driver operates the parking brake switch 18 to turn on the braking. If the calculation circuit 20 determines “YES” in S9, i.e., the driver operates the parking brake switch 18 to turn on the braking, the operation proceeds to the next step, S10. On the other hand, if the calculation circuit 20 determines “NO” in S9, i.e., the driver does not operate the parking brake switch 18 to turn on the braking, the operation proceeds to RETURN.

In S10, the calculation circuit 20 starts the emergency stop control on the brake apparatus on the normal side. More specifically, the calculation circuit 20 prohibits the operation of the electric actuator 43 of the disk brake 31 for which the emergency stop control has been prohibited in S5, S8, or S8, and activates the electric actuator 43 of the disk brake 31 for which the emergency stop control has not been prohibited in S5, S6, or S8 to advance the piston 39. At this time, the calculation circuit 20 can avoid the spin of the vehicle due to the sudden braking by activating (driving) the electric actuator 43 so as to more gradually increase the braking force than, for example, the braking force at the time of the application when the vehicle is stopped. Further, the calculation circuit 20 may perform the ABS control of preventing or reducing a slip of the wheel by activating or releasing the electric actuator 43 based on the wheel speed information detected by the control unit 13 of the ESC 11.

Next, after performing the control processing designed to be performed before the emergency stop control is performed as illustrated in FIG. 4, the calculation circuit 20 performs processing designed to be performed while the emergency stop control is in progress as illustrated in FIG. 6. More specifically, when the processing operation illustrated in FIG. 6 is started, in S11, the calculation circuit 20 determines whether the vehicle is running. The calculation circuit 20 makes this determination in a similar manner to the determination processing in above-described S1 illustrated in FIG. 4. If the calculation circuit 20 determines “YES” in S11, i.e., determines that the vehicle is running, the operation proceeds to the next step, S12. On the other hand, if the calculation circuit 20 determines “NO” in S11, i.e., determines that the vehicle is not running (the vehicle is stopped), the operation proceeds to RETURN.

In S12, the calculation circuit 20 determines whether the emergency stop control is in progress. The calculation circuit 20 can make this determination based on whether the driver is operating the parking brake switch 18 to turn on the braking. If the calculation circuit 20 determines “YES” in S12, i.e., determines that the emergency stop control is in progress, the operation, proceeds to S13. On the other hand, if the calculation circuit 20 determines “NO” in S12, i.e., determines that the emergency stop control is not in progress, the operation proceeds to RETURN.

In S13 to S18, the calculation circuit 20 performs similar processing to S3 to S8 illustrated in FIG. 4, and then the operation proceeds to the next step, step S19. result of the processing in S13 to S18 is reported to the driver as the failure information (the state in which the left wheel has failed, the state in which the right wheel has failed, the state in which both the left and right wheels have failed, or the state in which both the left and right wheels are normal).

Then, in S19, the calculation circuit 20 determines whether the request for the emergency stop control is issued. The calculation circuit 20 can make this determination based on whether the driver is operating the parking brake switch 18 to turn oh the braking. In this case, the driver has been already in the middle of performing the emergency stop control in S12, so that the determination in S19 is substantially equivalent to determining whether the driver has switched the parking brake switch 18 from operating it to turn on the braking to operating it to turn off the braking.

If the calculation circuit 20 determines “YES” in S19, i.e., determines that the driver continues operating the parking brake switch 18 to turn on the braking and the request for the emergency stop control is issued, the operation proceeds to step S20, where the calculation circuit 20 continues the emergency stop control on the disk brake 31 for which the emergency stop control has not been prohibited in S15, S16, or S18.

On the other hand, if the calculation circuit 20 determines “NO” in S19, i.e., determines that the driver is not operating the parking brake switch 18 to turn on the braking (the driver is operating the parking brake switch 18 to turn off the braking) and the request for the emergency stop control is released, the operation proceeds to S21, where the calculation circuit 20 releases the emergency stop control on the disk brake 31 on the normal side for which the emergency stop control has not been prohibited in S15, S16, or S18. As a result, the emergency stop control (i.e., the braking state) by all of the disk brakes 31 is released.

Therefore, according to the present embodiment, when one of the left and right disk brakes 31 is in the failed state, the parking brake control apparatus 19 prohibits the emergency stop control on this disk brake 31 in the failed state. Then, the parking brake control apparatus 19 can generate the braking force on the disk brake 31 on the normal side by the driver's operating the parking brake switch 18 to turn on the braking, when activating the parking brake so as to bring the vehicle to the emergency stop while the vehicle is running.

In other words, the parking brake control apparatus 19 is configured to activate the electric actuator 43 on the normal side of the left and right disk brakes 31 to advance the piston 39, when the parking brake switch 18 is operated toward the braking side while the vehicle is running. Due to this configuration, the parking brake control apparatus 19 can generate the braking force on the disk brake 31 on the normal side according to the driver's intention to stop the vehicle even when one of the left and right disk brakes 31 is in the failed state.

Further, the parking brake control apparatus 19 prohibits the emergency stop control on the disk brake 31 diagnosed as being in the failed state. Due to this prohibition, the parking brake control apparatus 19 can prevent or reduce a malfunction of the disk brake 31 in the failed state, thereby ensuring stability of the vehicle.

Further, the parking brake control apparatus 19 prohibits the emergency stop control on the disk brake 31 in the failed state, and thereby can cut off the supply of the current from the battery 14 to this disk brake 31. This cutoff can reduce a load on the battery 14.

Further, even when any one of the left and right disk brakes 31 is placed in the failed state while the emergency stop control is in progress, the parking brake control apparatus 19 can generate the braking force on the disk brake 31 on the normal wheel side by prohibiting the emergency stop control on the disk brake 31 in the failed state and the driver's continuing operating the parking brake switch 18 to turn on the braking.

In other words, the parking brake control apparatus 19 is configured to, even when one of the left and right disk brakes 31 is placed in the failed state with, for example, the running speed of the vehicle slowed down to some degree during the execution of the emergency stop control while the vehicle is running, activate the electric actuator 43 on the other normal wheel side to advance the piston 39. Due to this configuration, even when one of the left and right brake apparatuses is in the failed state, the parking brake control apparatus 19 can stop the vehicle further safely, i.e., while preventing or reducing the spin or the like of the vehicle, by generating the braking force on the brake apparatus on the normal wheel side according to the driver's intention.

The above-described embodiment has been described assuming that the parking brake control apparatus 19 diagnoses the failed state in which the left or right disk brake 31 is abnormal by way of example. However, the present invention is not limited thereto. For example, the parking brake apparatus may be configured to diagnose the operation of the left or right disk brake 31 as being normal, and permit the operation of the emergency stop control on the disk brake diagnosed as being normal.

Further, the above-described embodiment has been described assuming that the disk brake 31 equipped with the electric parking brake function is used as each of the brakes on the rear left and right rear wheel sides by way of example. However, the present invention is not limited thereto. For example, the disk brake equipped with the electric parking brake function may be used as each of the brakes on the all the wheels (ail of the four wheels). In other words, the disk brake equipped with the electric parking brake function can be used as the brake apparatuses on at least the pair of left and right wheels of the vehicle.

Further, for the normal wheel, the control may foe changed according to the speed. For example, the parking brake control apparatus 19 may perform the control so as to reduce the braking force when the vehicle is running at a high speed, and perform the control so as to increase the braking force when the vehicle is running at a low speed.

Having described several embodiments of the present invention, the above-described embodiments of the present invention are intended to only facilitate the understanding of the present invention, and are not intended to limit the present invention thereto. Needless to say, the present invention can be modified or improved without departing from the spirit of the present invention, and includes equivalents thereof. Further, the individual components described in the claims and the specification can be arbitrarily combined or omitted within a range that allows them to remain capable of achieving at least a part of the above-described objects or producing at least a part of the above-described advantageous effects.

The present application claims priority to Japanese Patent Application No. 2014-266811 filed on Dec. 27, 2014. The entire disclosure of Japanese Patent Application No. 2014-266811 filed on Dec. 27, 2014 including the specification, the claims, the drawings, and the abstract is incorporated herein by reference in its entirety.

### REFERENCE SIGH LIST

2 front wheel (wheel)

3 rear wheel (wheel)

4 disk rotor (rotational member)

6 brake pedal

18 parking brake switch

19 parking brake control apparatus (control apparatus)

31 disk brake (brake apparatus)

33 brake pad (frictional member)

39 piston

43 electric actuator (electric mechanism)

1. An electric brake system comprising:
at least a pair of braking apparatuses provided on a left side and a right side of a vehicle, each configured to advance a piston for pressing a frictional member against a rotational member rotatable together with a wheel and configured to press the frictional member against the rotational member with use of an electric mechanism according to a braking request signal and hold a pressing force of the frictional member; and
a control apparatus configured to control the electric mechanism of each of the brake apparatuses and diagnose whether the brake apparatus is in a failed state in which an abnormality has occurred in each of the brake apparatuses according to the braking request signal,
wherein this control apparatus is configured to, when any one of the brake apparatuses on the left side and the right side is diagnosed as being in the failed state, prohibit the electric mechanism of the one of the brake apparatuses from operating while the vehicle is running.

3. The electric brake system according to claim 1, wherein the control apparatus is configured to diagnose the failed state of each of the brake apparatuses when the electric mechanisms is activated to press the frictional member of the brake apparatus against the rotational member according to the braking request signal while the vehicle is in a running state.

3. The electric brake system according to claim 1, wherein, when any one of the brake apparatuses on the left side and the right side is diagnosed as being in the failed state, the control apparatus activates the electric mechanism of the other brake apparatus that is not diagnosed as being in the failed state while the vehicle is running.

4. The electric brake system according to claim 3, wherein the control apparatus activates the electric mechanism of the other brake apparatus so as to more gradually generate the pressing force than the activation of the electric mechanism when the vehicle is stopped.

5. An electric brake system comprising:
at least a pair of braking apparatuses provided on a left side and a right side of a vehicle, each configured to press (advance) a braking member against a braking target member based on driving of an electric actuator and hold a pressing force on the braking target member; and
a control apparatus configured to control the electric actuator of each of the brake apparatuses and diagnose a failed state in which an abnormality has occurred in each of the brake apparatuses according to the braking request signal,
wherein the control apparatus is configured to, when any one of the brake apparatuses on the left side and the right side is diagnosed as being in the failed state, prohibit the electric actuator of the one of the brake apparatuses from operating while the vehicle is running.
